(19) United States
(12) Patent Application Publication
(10) Pub. No.: US 2013/0152835 A1
(43) Pub. Date: Jun. 20, 2013

(54) MINIMAL TILL MANURE/FERTILIZER INJECTION APPLICATOR

(71) Applicants: Marc Allan Stevenson, Fillmore, IN (US); Jeffery Leroy Redick, Greencastle, IN (US)

(72) Inventors: Marc Allan Stevenson, Fillmore, IN (US); Jeffery Leroy Redick, Greencastle, IN (US)

(21) Appl. No.: 13/710,253

(22) Filed: Dec. 10, 2012

Related U.S. Application Data
(60) Provisional application No. 61/576,762, filed on Dec. 16, 2011.

(51) Int. Cl. A01C 5/00

(52) U.S. Cl. CPC A01C 5/00
USPC 111/163

(57) ABSTRACT

A manure/fertilizer injection applicator provides subsurface manure/fertilizer injection, even at low gallon per acre rates. The applicator of the present invention is a minimal till applicator that causes minimal soil disturbance compared to a conventional plow and, since the application is subsurface, there is no chance of run-off or evaporation of valuable nutrients. The applicator includes a mount to attach multiple applicators to an implement bar and a coulter till wheel to open a small ditch in the soil, an injection tube behind the till wheel for depositing manure or fertilizer, and at least one closer wheel to cover up the small ditch and to bury the manure or fertilizer.

### CROSS-REFERENCE TO RELATED APPLICATION

This application claims the benefit of priority of U.S. provisional application No. 61/576,762, filed Dec. 16, 2011, the contents of which are herein incorporated by reference.

### BACKGROUND OF THE INVENTION

The present invention relates to manure and fertilizer applicators and, more particularly, to a minimal till manure and fertilizer injection applicator.

A conventional plow cannot distribute manure and natural nutrients at a low enough gallon per acre rate in a subsurface application method. While surface application of manure can be accomplished at a low gallon per acre rate, this can lead to the possibility of run-off and evaporation of important nutrients.

As can be seen, there is a need for an improved device for providing a subsurface manure and/or fertilizer application.

### SUMMARY OF THE INVENTION

In one aspect of the present invention, a injection applicator for applying a subsurface product comprises a mounting plate operable to attach to an implement bar of a tractor; a main arm extending at an angle from the mounting plate, the main arm resiliently resisting movement upward, away from soil, when in use; a till wheel attached to the main arm; a secondary arm extending from the main arm; an injector tube supported by the secondary arm, the injector tube having an opening disposed behind the till wheel, wherein product delivered through the injector tube and out of the opening can be disposed in a ditch formed by pulling the till wheel over the soil; and at least one closer wheel disposed behind the injector tube, the closer wheel operable to cover the product in the ditch when in use.

In another aspect of the present invention, a injection applicator for applying a subsurface product comprises a mounting plate; one or more mounting brackets operable to secure the mounting plate to an implement bar of a tractor; a main arm extending at an angle from the mounting plate; a spring assembly operable to resiliently resist movement of the main arm upward, away from soil, when in use; a till wheel attached to the main arm; a secondary arm extending from the main arm; an injector tube supported by the secondary arm, the injector tube having an opening disposed behind the till wheel, wherein product delivered through the injector tube and out of the opening can be disposed in a ditch formed by pulling the till wheel over the soil; a closer arm pivotably attached to the secondary arm; and at least one closer wheel disposed behind the injector tube, attached to closer arm, the closer wheel operable to cover the product in the ditch when in use.

These and other features, aspects and advantages of the present invention will become better understood with reference to the following drawings, description and claims.

### BRIEF DESCRIPTION OF THE DRAWINGS

FIG. 1 is a perspective view of a manure/fertilizer injection applicator assembly according to an exemplary embodiment of the present invention;

FIG. 2 is a perspective view of one of the manure/fertilizer injection applicators of the assembly of FIG. 1;

FIG. 3 is a forward view of one of the manure/fertilizer injection applicators of the assembly of FIG. 1;

FIG. 4 is a top view of one of the manure/fertilizer injection applicators of the assembly of FIG. 1;

FIG. 5 is a side view of one of the manure/fertilizer injection applicators of the assembly of FIG. 1;

FIG. 6 is a side view of the manure/fertilizer injection applicator of FIG. 5, showing lifting and pivoting of the closer arm; and

FIG. 7 is a side view of one of the manure/fertilizer injection applicators of the assembly of FIG. 1, illustrating exemplary operation thereof.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a manure/fertilizer injection applicator for providing subsurface manure/fertilizer injection. The applicator of the present invention is a minimal till applicator and can provide low gallon per acre distribution of manure or fertilizer. The applicator causes minimal soil disturbance compared to a conventional plow and, since the application is subsurface, there is no chance of run-off or evaporation of valuable nutrients. The applicator includes a mount to attach multiple applicators to an implement bar and a coulter till wheel to open a small ditch in the soil, an injection tube behind the till wheel for depositing manure or fertilizer, and at least one closer wheel to cover up the small ditch and to bury the manure or fertilizer.

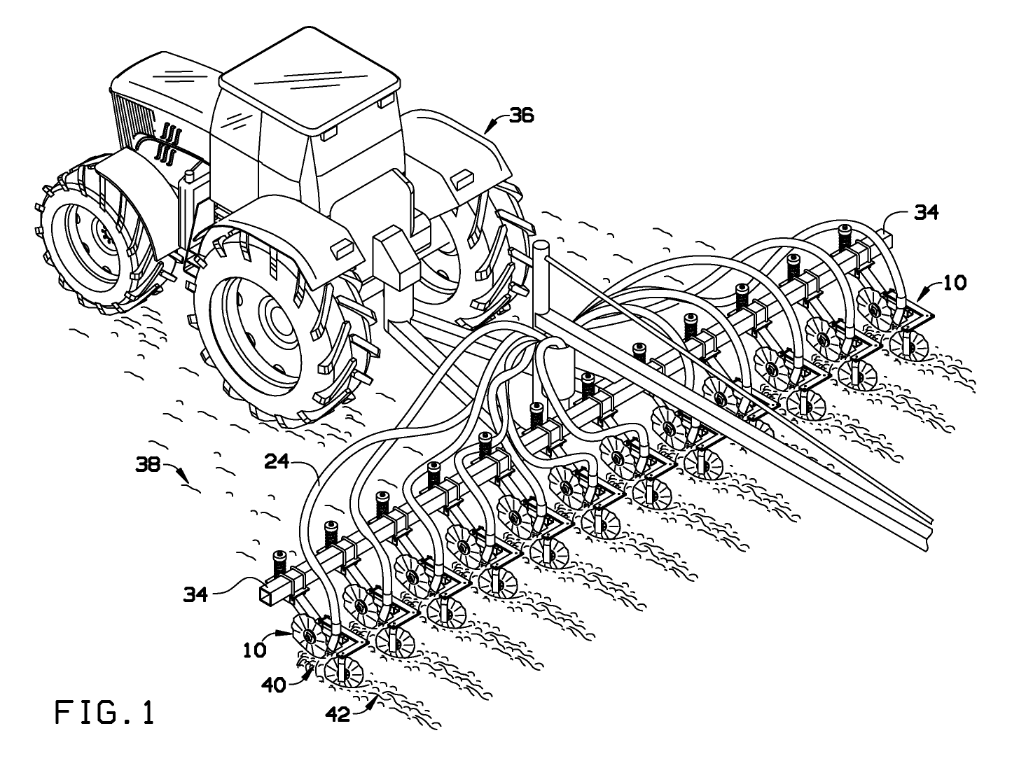

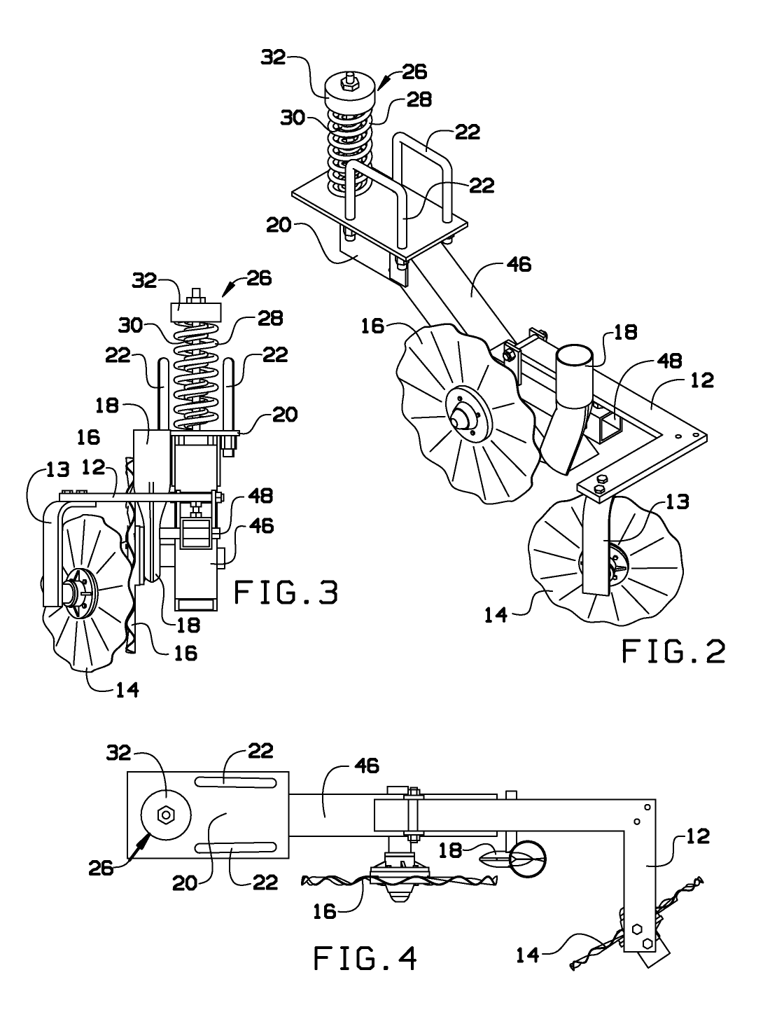

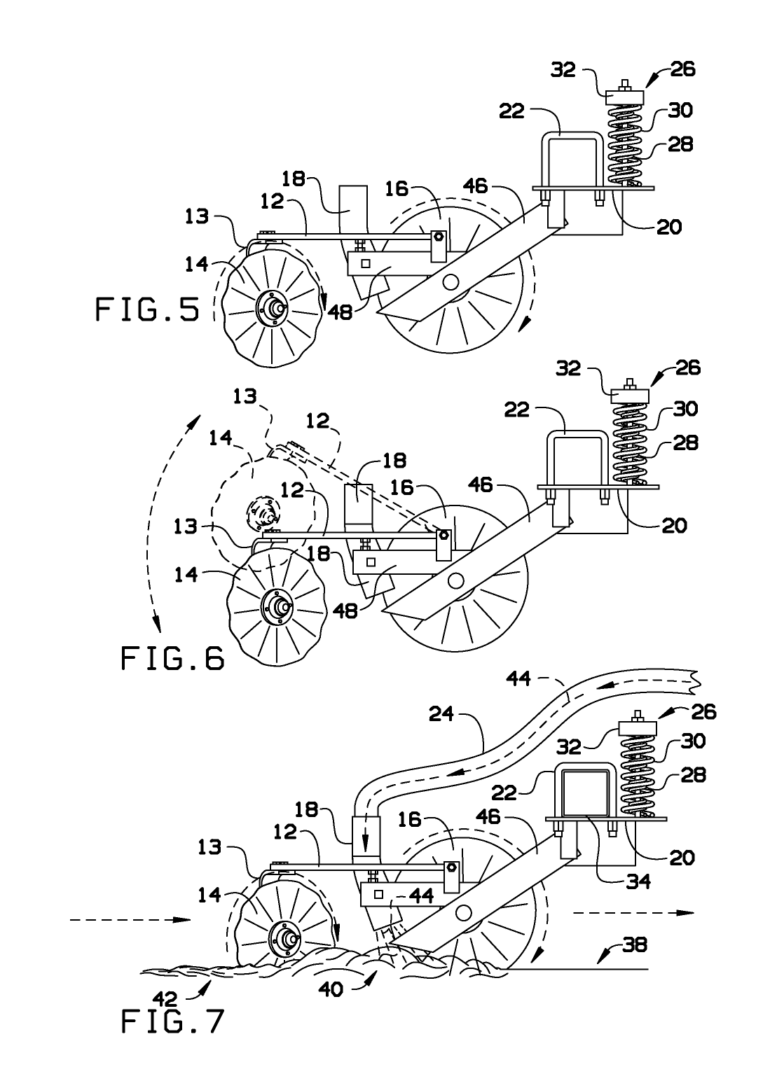

Referring now to FIG. 1, a plurality of minimal till manure/fertilizer injection applicators 10 can be attached to an implement bar 34 and pulled by a tractor 36. The injector applicators 10 can pass over undisturbed ground 38, create a shallow ditch 40, inject fertilizer via a hose 24, and cover the ditch 40 to form closed ground 42. Typically, from about 7 to about 18 of the injection applicators 10 can be used in the applicator assembly of the present invention. The injection applicators 10 are described in greater detail below with respect to FIGS. 2 through 7.

The injection applicators 10 can include a mounting bracket 22 extending from a mounting bracket body 20. The mounting bracket 22 can be formed in various configurations provided that it secures the injection applicators 10 to the implement bar 34. Typically the mounting bracket body 20 is a flat plate with at least two U-shaped clamps extending therefrom. The implement bar 34 can fit between the mounting bracket body 20 and the U-shaped clamps (mounting brackets 22) and the mounting brackets 22 can be tightened to secure the injection applicators 10 to the implement bar 34. In some embodiments, the mounting bracket 22 can be a ⅞ inch U-bolt that is about 7 inches wide and about 7 inches long. In some embodiments, the mounting bracket body 20 can be a ⅝ inch steel plate about 10 inches wide and about 13.25 inches long.

A main arm 46 can extend downward, at an angle from about 20 to about 50 degrees, from the mounting bracket body 20. In some embodiments, the main arm can be a 4-inch by 4-inch square tubing, having a 5/16 inch thick wall an extending about 26.5 inches long. The main arm 46 can be resiliently maintained at the angle but can be angled upward, typically against the force of one or more springs. This can be achieved in various configurations.

One such configuration for providing downward pressure from the main arm 46, as shown in the Figures, includes a bolt attached to one end of the main arm 46, extending through the mounting bracket body 20 and terminating with a spring cap 32. One or more springs 26 can be disposed between the mounting bracket body 20 and the spring cap 32. Typically, an external spring 28 and an internal spring 30 can be disposed between the mounting bracket body 20 and the spring cap 32. When a lifting force is applied to an opposite end of the main arm 46 (opposite of where the main arm 46 attaches to the mounting bracket body 20), the main arm 46 can be lifted against the force of the springs 28, 30. This configuration provides a downward pressure to cut the ditch with the proper resistance to lifting of the main arm. The spring tension can be adjusted depending on soil type, desired depth, and the like. While the Figures show a round spring cap 32, other shapes can be used within the scope of the present invention.

The main arm 46 can support a till wheel 16 therefrom. The till wheel 16 can be, for example, a 22-inch, 13-wave coulter blade, but other designs, sizes and styles of the till wheel 16 may be contemplated within the scope of the present invention. The till wheel 16 can be disposed at a slight angle relative to the direction of travel of the injection applicator 10. Typically, this small angle can be from about 4 to about 8 degrees, often about 6 degrees. When in use, the till wheel 14 can be designed to form a trench of appropriate width and depth.

A secondary arm 46 may extend from the main arm 46. The secondary arm 46 can be approximate parallel with the ground during use of the injection applicator 10. The secondary arm 46 can pivotably support a closer arm 12 that extends behind the till wheel 16. A closer bracket 13 can be attached to an end of the closer arm 12 to support a closer wheel 14. Typically, the closer wheel 14 can be 16-inch, 10-notch disc, but other designs, sizes and styles of the closer wheel 14 are contemplated within the scope of the present invention. The closer wheel 14 can be disposed at an angle to permit the closer wheel 14 to cover the ditch as the closer wheel is moved along the ground. While one closer wheel 14 is shown in the Figures, two closer wheels, angled toward each other, could be used to cover the ditch during use.

The secondary arm 44 can also support an injector tube 18. The injector tube 18 can receive fertilizer or manure 44 through a hose 24. The injector tube 18 terminates to deliver manure or fertilizer into the ditch formed by the till wheel 16.

While the above discusses feeding manure and/or fertilizer through the tube 18 and into the ditch formed by the till wheel 16 and covered by the closer wheel 14, other items can be distributed with the system of the present invention. For example, other types of dry or liquid chemical fertilizer can be spread with the system of the present invention. For example, anhydrous ammonia could be delivered, subsurface, to a cut ditch and quickly covered by the system of the present invention.

While exemplary dimensions of certain elements of the system of the present invention are described above, the sizes can be changed according to application.

It should be understood, of course, that the foregoing relates to exemplary embodiments of the invention and that modifications may be made without departing from the spirit and scope of the invention as set forth in the following claims.

What is claimed is:

1. An injection applicator for applying a subsurface product, comprising:
a mounting plate operable to attach to an implement bar of a tractor;
a main arm extending at an angle from the mounting plate, the main arm resiliently resisting movement upward, away from soil, when in use;
a till wheel attached to the main arm;
a secondary arm extending from the main arm;
an injector tube supported by the secondary arm, the injector tube having an opening disposed behind the till wheel, wherein product delivered through the injector tube and out of the opening can be disposed in a ditch formed by pulling the till wheel over the soil; and
at least one closer wheel disposed behind the injector tube, the closer wheel operable to cover the product in the ditch when in use.

2. The injection applicator of claim 1, wherein a spring assembly provides resistance against the main arm moving upward.

3. The injection applicator of claim 2, wherein the spring assembly includes an inner spring and an outer spring disposed on the mounting plate.

4. The injection applicator of claim 1, further comprising one or more mounting brackets operable to secure the mounting plate to the implement bar.

5. The injection applicator of claim 1, further comprising a closer arm pivotably attached to the secondary arm, the at least one closer wheel attached to the closer arm.

6. The injection applicator of claim 5, further comprising a closer bracket attaching the closer wheel to the closer arm.

7. The injection applicator of claim 1, wherein the till wheel is a coulter blade.

8. The injection applicator of claim 1, wherein the product is selected from a fertilizer and manure.

9. An injection applicator for applying a subsurface product, comprising:
a mounting plate;
one or more mounting brackets operable to secure the mounting plate to an implement bar of a tractor;
a main arm extending at an angle from the mounting plate;
a spring assembly operable to resiliently resist movement of the main arm upward, away from soil, when in use;
a till wheel attached to the main arm;
a secondary arm extending from the main arm;
an injector tube supported by the secondary arm, the injector tube having an opening disposed behind the till wheel, wherein product delivered through the injector tube and out of the opening can be disposed in a ditch formed by pulling the till wheel over the soil;
a closer arm pivotably attached to the secondary arm; and
at least one closer wheel disposed behind the injector tube, attached to closer arm, the closer wheel operable to cover the product in the ditch when in use.

10. The injection applicator of claim 9, wherein the spring assembly includes an inner spring and an outer spring disposed on the mounting plate.

11. The injection applicator of claim 9, further comprising a closer bracket attaching the closer wheel to the closer arm.
